(19) United States
(12) Patent Application Publication
(10) Pub. No.: US 2003/0216939 A1
(43) Pub. Date: Nov. 20, 2003

(54) Clinical pathway management support information system

(75) Inventors: Yoshitaka Bito, Kawaguchi (JP); Shigeo Sumino, Fuchu (JP); Hajime Sasaki, Kawasaki (JP); Hideyuki Ban, Hachioji (JP); Ryo Watanabe, Tokyo (JP)

Correspondence Address: Stanley P. Fisher, Reed Smith LLP, Suite 1400, 3110 Fairview Park Drive, Falls Church, VA, 22042-4503, US

(73) Assignee: Hitachi, Ltd.

(21) Appl. No.: 10/212,876

(22) Filed: Aug. 7, 2002

(30) Foreign Application Priority Data
May 14, 2002 (JP) 2002-137918

(51) Int. Cl. G06F 17/60

(52) U.S. Cl. 705/2

(57) ABSTRACT

A method of feeding back results of analysis of care record to clinical service efficiently, and an information system therefor. A clinical pathway management support information system according to the present invention uses a clinical pathway analysis environment 15 which has a module for analyzing stored care record and making, modifying, and storing clinical pathways. In addition, the information system has a module 17 for selecting an appropriate clinical pathway according to a patient status. The clinical pathway analysis environment 15 also has a care process evaluation module and a clinical pathway evaluation module. The above modules support creation of a more realistic clinical pathway and its modification, selection of a clinical pathway appropriate to each patient, and clinical service which is in line with a clinical pathway.

### BACKGROUND OF THE INVENTION

1. Field of the Invention

The present invention relates to a medical information system and information service. Particularly it concerns software for feeding back results of analysis of care process data to clinical service using a clinical pathway (standard or optimum care process), making a clinical pathway, evaluating a degree of compliance between a clinical pathway and care process data, and selecting an appropriate clinical pathway, and a medical information system incorporating the software, and medical information service based on the medical information system.

2. Description of the Related Art

The prior art concerning clinical pathways is explained next. A clinical pathway refers to a standard or optimum care process. It is also sometimes called a “critical pathway.” On the other hand, there are so-called “clinical guidelines” for optimum clinical service. This specification assumes that clinical pathways include clinical guidelines. Here, a “care process” represents a series of clinical services. For further information on clinical pathways, refer to “Nursing Informatics,” Springer-Verlag, pp. 167-183, 1995, and “Critical Pathway,” Bunkodo, 1998. Several groups of prior art related to the present invention are detailed next.

Prior Art Group 1: This group concerns a conventional method or system for analysis of care process data. JP-A No. 181981/2000 discloses a method in which data is warehoused together with time information and extraction and analysis of care process data are carried out using the time information. JP-A No. 101296/2001 discloses a system that displays all care process data for a particular patient on a screen in chronological order. In the method described in “Proceedings of the 17^{th} Joint Conference on Medical Informatics,” pp. 140-141, 1997, care process data statistics are calculated and displayed in chronological order.

Prior Art Group 2: This group concerns a conventional method of making a clinical pathway. A typical method of making a clinical pathway is as follows. A clinical pathway making team, which consists of expert doctors, nurses and others, is organized for a case and a clinical pathway for the case is determined based on their experience, and by reference to patient record and related literature. This method is stated in the above-mentioned book “Critical Pathway.”Prior Art Group 3: This group concerns a conventional method of determining a degree of compliance of a care process with a clinical pathway. If a care process departs from its clinical pathway or is switched to another clinical pathway, this event is called a “variance.” From analysis of the event, which is called variance analysis, an index which shows to what degree the care process complies with the clinical pathway will be obtained. For instance, the number of variances or variance frequency is calculated and used as an index and information such as “the frequency is high for a variance” can be obtained. For further information on this method, again refer to “Critical Pathway.”

Prior Art Group 4: This group concerns a conventional method of selecting a suitable clinical pathway for each patient. JP-A No. 273362/2001 discloses a method by which patient basic information including diagnosis, age and gender is inputted and a clinical guideline or clinical pathway which meets the inputted conditions is acquired and outputted from a data base. Further, JP-A No. 118014/2001 describes a method by which a suitable treatment process for a patient is selected, though it is not a clinical pathway. In this method, a care record similar to record of care rendered to a patient up to a specific point of time is extracted.

Prior Art Group 5: This group concerns a conventional method of supporting care which is in line with a clinical pathway. Japanese patents 2706645 and 2815346 describe methods of showing, in tabular form, record of care so far done on a patient and a care plan to be followed thereafter. Also, JP-A No. 101296/2001 discloses a system which can collectively send orders for care to be done on a patient in line with a clinical pathway.

The above prior art group 1 does not pay attention to a method or information system for efficient feedback of analysis results to clinical service though it focuses on storage and analysis of care record. Also, the above prior art group 5 focuses on clinical practice support but does not take into account how to reflect the result of analysis of care record in clinical service.

In the above prior art group 2 concerning a method of making a clinical pathway, most of the process must be carried out by manual work and thus the problem of inefficiency is to be solved. In addition, since it relies on human experience and patient record retrieval results, an unrealistic clinical pathway may sometimes be produced due to lack of sufficient and appropriate sampling data. In combination with time-series visualization of care record (in prior art group 1), it enables the user to create a clinical pathway while looking at displayed information on the screen, but the user must additionally make a comparison between the clinical pathway and analysis results and so on, leading to a low working efficiency. Besides, when care processes are extracted based on patient basic information including the name of a disease (diagnosis), gender, and age, the extracted care processes may include ones for cases whose type is different from the type of the case in question; this means that the user has to exclude the influence of such foreign care processes in the course of making a clinical pathway.

In the above method of evaluating care processes (prior art group 3), variances which may occur in the course of making a clinical pathway must be set. Therefore, the standard (criteria) for care process evaluation must vary from one clinical pathway to another, so it is impossible to make an evaluation across multiple clinical pathways. Similarly, in this conventional technique, clinical pathways can be individually evaluated one by one but it is also impossible to make an evaluation and a comparison across multiple clinical pathways.

In the above method of selecting a clinical pathway (prior art group 4), patient basic information including diagnosis, age and gender is used as parameters to extract an appropriate clinical pathway. However, this method fails to select an appropriate clinical pathway depending on the progress of care and patient status change over time. Besides, it does not take into consideration the following factors: restrictions such as availability of equipment/facilities in each healthcare provider and types of operation which can be implemented as well as the course of care adopted. Furthermore, when similar care records are extracted, an extracted care process does not always suggest an appropriate care process.

### SUMMARY OF THE INVENTION

An object of the present invention is to provide a method that efficiently feeds back results of analysis of care record to clinical service and an information system therefor. More specifically, the present invention is intended to provide a method of making a clinical pathway easily, a method of evaluating a degree of compliance of care processes with a clinical pathway and a method of selecting an appropriate clinical pathway. Also, it is another object to provide clinical information service which incorporates these methods (functions).

In order to solve the above problems, a clinical pathway management support information system according to the present invention has a clinical pathway analysis environment 15 in which analysis of data such as care record and cost is made, a clinical pathway is created and various evaluations are made, as shown in FIG. 1. This analysis environment has all or some of the following three functions (modules). The first function is a case mix & clinical pathway making module which analyzes care record and cost data, etc, makes a case mix and a clinical pathway and stores them in a case mix-clinical pathway relation data base 16. The second function is a care process evaluation module which calculates the difference between care process data and a clinical pathway. The third function is a clinical pathway evaluation module which calculates the difference between care process data and a clinical pathway and evaluates and modifies the clinical pathway based on the calculated difference. This environment and the above-mentioned functions permit accumulation of results of analysis of care record in a form which is easily accessible in the course of clinical service.

Particularly, as shown in FIG. 2, the case mix & clinical pathway making module has a care process selection step, an average process calculation step for the selected processes, a clinical pathway initializing step for the average process, a clinical pathway editing step, and a clinical pathway storing step for the completed clinical pathway. This composition makes it easy to make a clinical pathway which suits actual clinical service. The care process selection step may use care process visualization which displays care process statistics as a two-dimensional matrix consisting of time and service item axes and a one-dimensional graph representing statistics for each care process, selects the region of interest in both graphs, and displays only statistics for care processes which fall within the region of interest. This enables the user to select the care process to be used for making a clinical pathway while observing the care process time-series pattern. It is also possible to define a distance metric between care processes and add the step of care process clustering according to the metric to the care process selection step. This enables extraction of uniform care processes, thereby reducing the time and labor required to edit a clinical pathway.

Another possible approach is to use the above distance metric between care processes for the care process evaluation step and clinical pathway evaluation step and introduce an index derived from the distance metric between each care process and a clinical pathway. This makes it possible to make comparison across plural clinical pathways and case mixes and obtain a standard or criterion according to which a decision is made as to which clinical pathway should be emphatically improved, whether a new clinical pathway should be created or not, or which care process should be worked on to make it match the clinical pathway.

According to one aspect of the present invention, as shown in FIG. 1, a clinical pathway management support information system may have an appropriate clinical pathway selection module 17 which selects an appropriate clinical pathway based on all or some of information including patient basic information for diagnosis and his/her care record up to a specific point of time, restrictions for the healthcare provider and the course of care adopted by them. This makes it easy to utilize clinical pathways warehoused in the case mix-clinical pathway relation database 16.

According to another aspect of the present invention, a clinical pathway management support information system can provide clinical pathway management support service as shown in FIG. 12. In this service, information including patient information and care process data is received from a healthcare provider as a client and an appropriate clinical pathway for the patient concerned, and relevant case mix/clinical pathway data and care process evaluation data are delivered to improve the clinical pathway and case mix. This service promotes collection and accumulation of care process data related to a specific case from plural healthcare providers, which makes it easy to improve the clinical pathway for the case. Each healthcare provider can obtain an improved clinical pathway and thus enhance the quality of clinical service. In addition, it is possible to make evaluation or comparison across plural healthcare providers, thereby providing a guideline which can be used to improve the quality of service by healthcare providers.

Other and further objects, features and advantages of the invention will appear more fully from the following description.

### BRIEF DESCRIPTION OF THE DRAWINGS

The invention will be more particularly described with reference to the accompanying drawings, in which:

FIG. 1 is a conceptual diagram showing a clinical pathway management support information system according to the present invention;

FIG. 2 is a conceptual diagram showing the method of making a clinical pathway according to the present invention;

FIG. 3 is a flowchart showing the operational sequence for making a clinical pathway according to the present invention;

FIG. 4 shows an example of the care process and clinical pathway data schema according to the present invention;

FIG. 5 shows a typical screen transition in the method of making a clinical pathway according to the present invention;

FIG. 6 shows typical screens for evaluation of a clinical pathway created by the method of making a clinical pathway according to the present invention;

FIG. 7 is a flowchart showing a typical operational sequence where a process clustering step is added to the method of making a clinical pathway according to the present invention;

FIG. 8 is a conceptual diagram showing the introduction of metric calculation concerning the distance between processes;

FIG. 9 shows a typical screen transition where a process clustering step is added to the method of making a clinical pathway according to the present invention;

FIG. 10 is a flowchart showing the operational sequence for evaluating the degree of compliance of each care process with a clinical pathway using the distance between processes;

FIG. 11 shows a typical screen transition for the appropriate clinical pathway selection module according to the present invention; and

FIG. 12 shows the general structure of the clinical pathway management support information system according to the present invention.

### DETAILED DESCRIPTION OF THE PREFERRED EMBODIMENTS

Next, preferred embodiments of the present invention will be described referring to the accompanying drawings.

Exemplary Embodiment 1

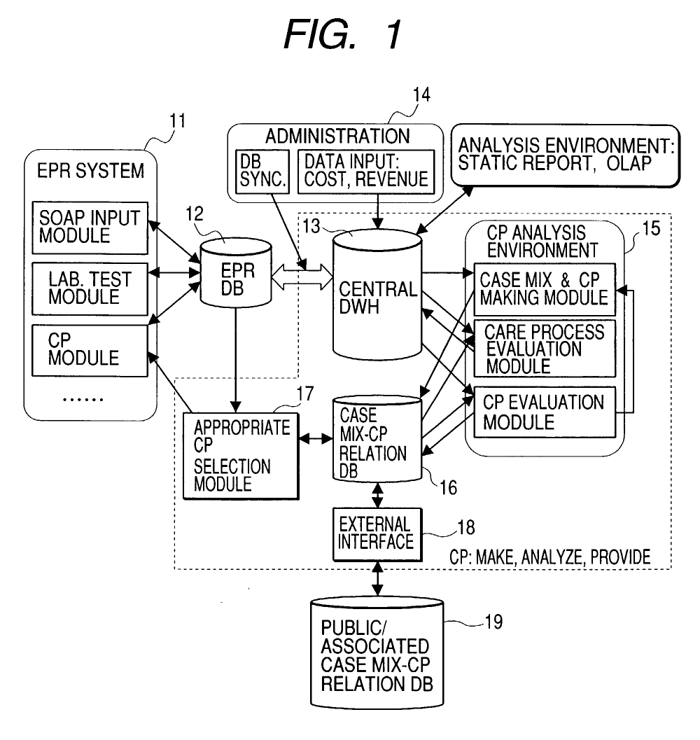

FIG. 1 is a conceptual diagram showing a clinical pathway management support information system according to the present invention. Care record and test data are entered into an EPR (electrical patient record) system 11 and stored in an EPR database 12. In the figure, the modules shown in the frame representing the EPR system 11 are typical EPR system modules (functions). Among these modules, the SOAP input module enables the user to do input work while classifying care record data into four categories: Subjective, Objective, Assessment and Plan. The clinical pathway (CP) module permits reference to an appropriate pathway for each patient, its customization, and ordering. In addition to these typical functional modules, for example, an image diagnosis module for radiology and/or a nursing module may be incorporated. In the present invention, the clinical pathway module is essential but other modules are omissible. Terminal equipment for the EPR system 11 may be a stationary desk top computer in an examination room or a mobile laptop computer or personal digital assistant (PDA) usable in a hospital ward or outside a hospital. The data stored in the EPR database 12 is reflected in a central data warehouse (DWH) 13 in a timely manner: for example, at the time of ordering or care record input/storage, or every day or at a fixed time of each day, or upon recovery of the central data warehouse 13 from a system failure. This synchronizes the data in the EPR database 12 with that in the central data warehouse 13. Also, even when the central data warehouse 13 is seriously loaded as it is frequently referred to or used for analysis, there will be no influence on response to care record input because the EPR database 12 is independent. The central data warehouse 13 stores not only care record data but also data about cost, revenue, and so on. Synchronization between the EPR database 12 and the central data warehouse 13 as well as input of cost and revenue are performed through an administration 14. Alternatively, cost, revenue, and other related data may be automatically transmitted from another medical accounting system, ordering system or cost accounting system, or the EPR database 12 and central data warehouse 13 may be synchronized with a database in any such system. When such data is added, a care process can also be analyzed from the viewpoints of revenue, cost and profit.

The data thus warehoused is analyzed in different analysis environments using statistical methods or the like. Particularly, a clinical pathway analysis environment 15 is characteristic of the present invention. In this environment, the data stored in the central data warehouse 13 is analyzed in terms of a clinical pathway and care processes, and data to be fed back to clinical service is generated. Concretely, the clinical pathway analysis environment 15 has modules whose names appear in the frame representing it in the figure. The case mix & clinical pathway making module analyzes the data stored in the central data warehouse 13, makes a case mix and a clinical pathway and stores the relation between them in a case mix-CP relation database 16. This module offers an advantage that a clinical pathway can be made based on actual clinical service data. How this module works will be explained in detail later in the explanation of embodiment 2. Here, when a clinical pathway is stored, numerical values which may be used as indices for the selection of a clinical pathway may also be stored. Such numerical values include, for example, data on cure ratios, needs for nursing, and overall cost, revenue and profit concerning implementation of the clinical pathway concerned. Using these numerical values and an index induced therefrom, an appropriate clinical pathway can be selected.

In the care process evaluation module, a care process is extracted from the central data warehouse 13, a clinical pathway which matches it is selected from the case mix-clinical pathway relation database 16 and how much the extracted care process deviates from the clinical pathway is calculated. The result of the calculation is recorded in the central data warehouse 13 and referred to by the clinical pathway module, etc in the EPR system 11. This module produces an effect that a healthcare provider, care unit or doctor or case for which CP-based process control should be intensified can be searched.

The clinical pathway evaluation module does the same calculations as the care process evaluation module. However, it is different in that the evaluation result is reflected in clinical pathway modification or selection. For this purpose, the evaluation result is recorded in the case mix-CP relation database 16 and used as a criterion for evaluation when an appropriate clinical pathway selection module 17 selects a clinical pathway. Also, if the clinical pathway is least associated from the actual care process and has to be modified, it is returned to the case mix & clinical pathway making module where it is modified. A method of calculating the difference between the clinical pathway and care process which is used in these two modules will be explained in detail later in the explanation of embodiment 3. For the information system as proposed by the present invention, the care process evaluation module and clinical pathway evaluation module are not indispensable; however, they contribute to improvement in the clinical pathway and, from a macroscopic viewpoint, improvement in the quality of clinical service.

A public/associated case mix-CP relation database 19 warehouses case mix and clinical pathway data, like the case mix-CP relation database 16. An external interface 18 transforms data to be exchanged between the two databases, modifies the data in the case mix-CP relation database 16 based on the public/associated case mix-CP relation database 19 and sends data to the public/associated case mix-CP relation database 19. This permits introduction data from the outside and thus improves the case mix-CP relation database 16.

As mentioned above, in the clinical pathway analysis environment 15, clinical pathways are made and such data as their scope and priority are stored in the case mix-clinical pathway relation database 16. The appropriate clinical pathway selection module 17 selects an appropriate clinical pathway for a patient and calculates priority among clinical pathways. Information which is used to assign a clinical pathway to a patient includes the patient's basic information in the EPR system 11 (gender, age, diagnosis, etc) and the record of care rendered to the patient by a specific time in the EPR database 12. Using this information about the patient combined with information about restrictions for the healthcare provider, care unit, doctor and other party concerned and the course of care adopted, an appropriate clinical pathway is selected from the case mix-clinical pathway relation database 16 and displayed or clinical pathways from the database 16 are prioritized and displayed. Particularly, the use of the record of care rendered to the patient by a specific time makes it possible to select a clinical pathway suitable for the patient status dynamically. How the appropriate clinical pathway selection module 17 works will be explained in detail later in the explanation of embodiment 4. The doctor, etc selects a suitable one from the displayed clinical pathways, and if necessary, customizes it for the patient concerned. Once the clinical pathway is completed, it is possible to book clinical service which can be ordered in advance, and issue an order.

The present invention's information system is not limited to its application to a single healthcare provider; it can be applied to a plurality of healthcare providers. If the system is shared by more than one healthcare provider, the modules for making, evaluating and delivering clinical pathways should be independent from the healthcare providers while each healthcare provider has its own EPR system and care record. The independent part of the system provides the plural healthcare providers with clinical pathway management support service which is based on the functions of the various modules and the results of their operation. In this case, each of the healthcare providers can save labor in the maintenance, etc of clinical pathways and get more accurate case mix and clinical pathway data because the data also includes data collected from the other healthcare providers. Furthermore, they are subjected to a care process evaluation, which means that they can be compared with the other healthcare providers. This service will be explained in detail later in the explanation of embodiment 5.

Exemplary Embodiment 2

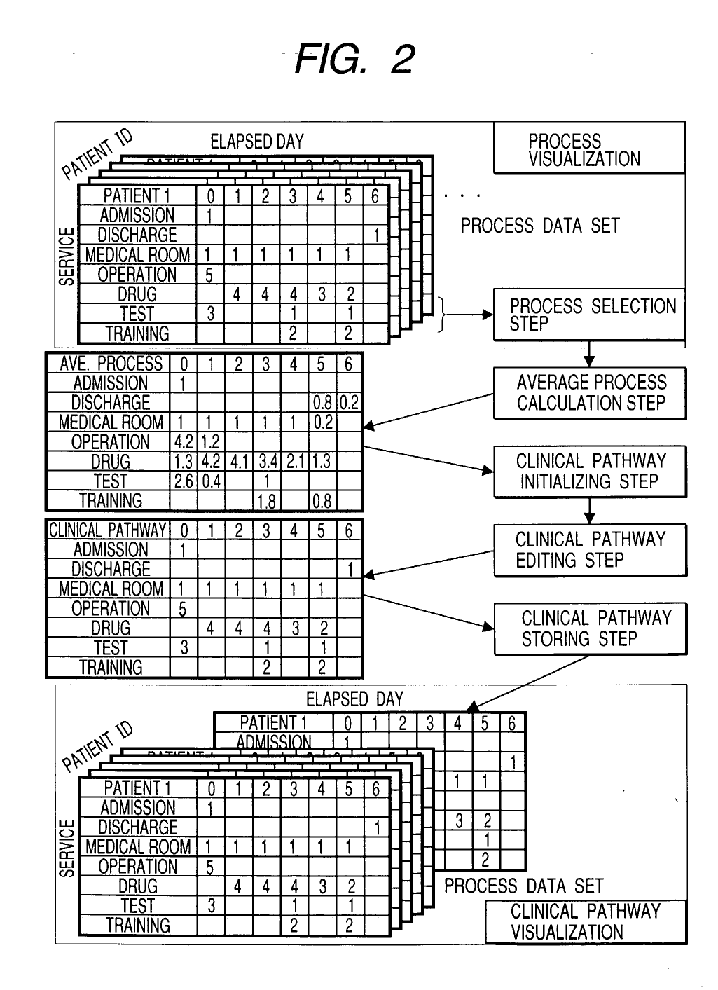

FIG. 2 is a conceptual diagram showing the method of making a clinical pathway according to the present invention. This method is used in the case mix & clinical pathway making module in the clinical pathway analysis environment 15 as shown in FIG. 1. Each process in a process data set refers to record of a series of clinical services which consist of three factors: duration of service (elapsed day), service item (clinical service) and quantity. Here, “quantity” refers to the amount or duration of clinical service, clinical service cost, and revenue and profit from clinical service. When a clinical service is a test or measurement, a measured value may be treated as “quantity” data. When a clinical service is medication or injection, dosage may be treated as “quantity” data. In FIG. 2, each process is expressed by a two-dimensional matrix in which the columns and rows represent elapsed day(s) and service items, respectively, with the cells for quantitative data. This process data set is displayed by process visualization and only a process subset of interest is selected at the process selection step. Here, process visualization typically uses a two-dimensional matrix expressing a time-series pattern consisting of elapsed days and service items, and a one-dimensional graph indicating statistics for each process, where there is a function of selection projection to show the areas of interest on both graphs. Thanks to this function, the areas of interest can be set on the one-dimensional graph to select processes and an average process from the selected processes can be observed on the two-dimensional matrix. As a consequence, it is possible to extract a group of patients to whom virtually uniform care processes suitable for making a clinical pathway have been rendered. The process selection step may include a patient selection step based on patient basic information such as diagnosis, gender, age, operation and ethnic group. An average process is calculated from the selected processes by an average process calculation step and defined as an initial clinical pathway by a clinical pathway initializing step. At a clinical pathway editing step, numerical calculation including threshold processing and rounding as well as modification and shift of numerical data and addition of new service items by the operator are carried out to complete a clinical pathway. The completed clinical pathway is stored at a clinical pathway storing step and displayed by clinical pathway visualization. This clinical pathway visualization may be the same as the process visualization; it should display the completed clinical pathway and the recorded processes to enable comparison between them and analysis of them. When an average care process as an initial clinical pathway is set based on various data in this way, a realistic clinical pathway which suits actual care practice can be easily created. In addition, the combination of the two-dimensional matrix and the one-dimensional graph allows a process data set to be displayed in an apprehensible manner, thereby facilitating selection of a process of interest.

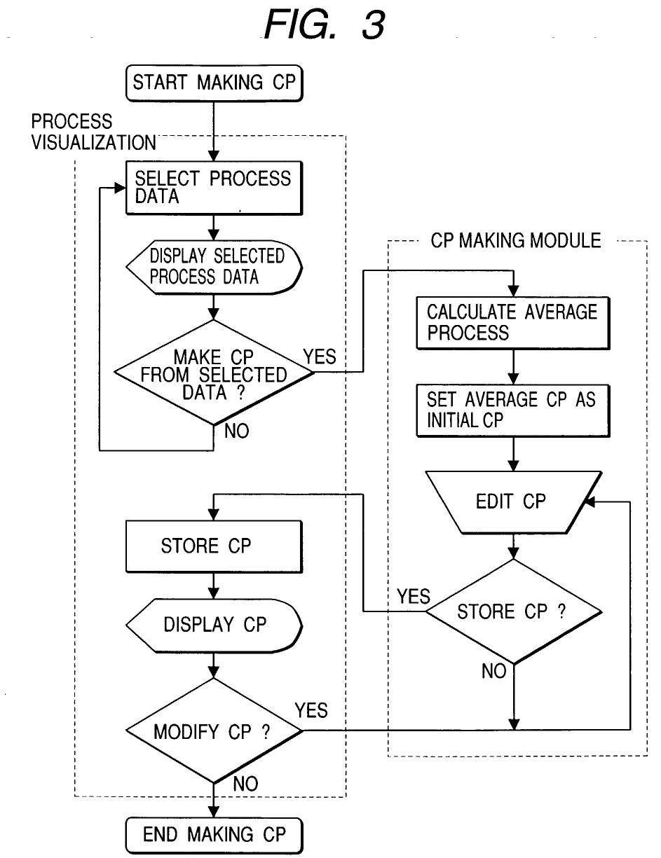

FIG. 3 is a flowchart showing a typical operational sequence for making a clinical pathway according to the present invention. In order to make a clinical pathway, process data is first selected and the selected process data is displayed on a process display. The user decides whether or not to make a clinical pathway from the selected data. If no, the system goes back to the step of process data selection. If yes, the clinical pathway making module calculates an average process from the selected processes and the calculated average process is defined as an average clinical pathway. The user edits the clinical pathway by numerical calculation, modification or shift of numerical data, addition, deletion, or other operation to complete the clinical pathway as desired. Then, the user decides whether or not to store the completed clinical pathway. If yes, the clinical pathway is stored. The stored clinical pathway is displayed on the process display together with process record. The user compares the displayed clinical pathway with the process record and decides whether or not to modify the clinical pathway. If yes, it is edited through the clinical pathway editing step and this series of editing operations is repeated until the desired clinical pathway is obtained. This flowchart merely shows a typical operational sequence for making a clinical pathway, and it is needless to say that another sequence may be used. For example, although this flowchart uses a decision tree to show bifurcation of steps, instead events and event handlers may be used for choice as used commonly in display programs. Also, as an alternative way of modifying an existing clinical pathway, the existing clinical pathway and an average process from selected processes may be shown simultaneously to facilitate modification of the existing clinical pathway.

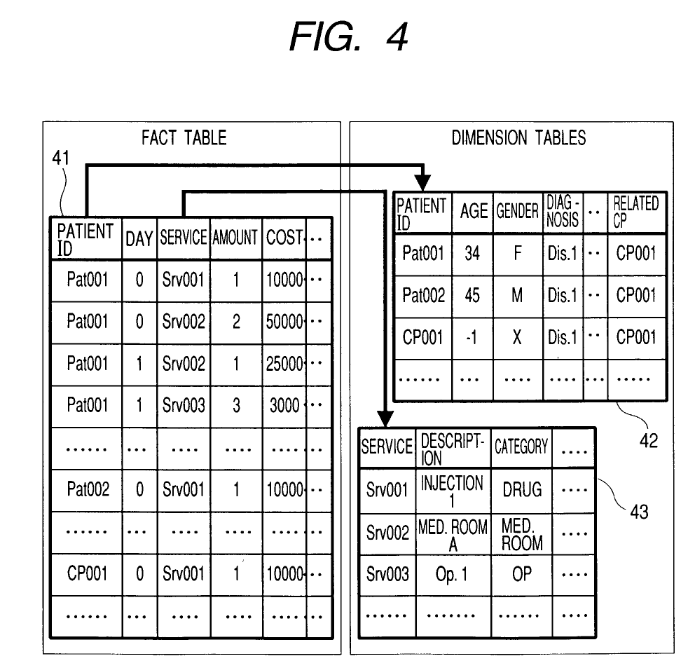

FIG. 4 shows an example of a process data set and clinical pathway data schema. The data schema is a star schema which consists of a fact table and dimension tables. The fact table on the left consists of a process table 41. The process table 41 records patient ID, elapsed day(s), service item, and care quantity (amount, cost, etc). One of the dimension tables on the left is a patient table 42 which records patient basic information and the other is a clinical service item table 43 which describes the content of clinical service. For instance, the patient table 42 indicates that a patient with patient ID “Pat 001” is a 34-year-old woman with a disease called “Disease 1.” “CP001” under the Patient ID column denotes a completed clinical pathway. In this figure, the patient table 42 includes the Related CP column, a column which indicates the ID of a related clinical pathway. This Related CP column enables the user to know which clinical pathway is related to which patient group. Here, the table 42 has only one “Related CP” column. However, actually there may be more than one related clinical pathway: for example, a clinical pathway actually used in clinical service, an original clinical pathway allocated to a selected patient in the clinical pathway making process and so on. The Related CP column, which has been introduced in order to clarify the relation between the patient and an appropriate clinical pathway, is not indispensable. In this data form, patient care process data and clinical pathway data are included in the same data schema (process table 41 and patient table 42); however, another data schema may be used for clinical pathway data. For example, instead of the process table 41 containing both patient care process data and clinical pathway data, a separate clinical pathway table may be prepared to record clinical pathway data in a similar way. When patient care process data and clinical pathway data exist in the same data schema, the data can be handled in a uniform manner but it is necessary to rely on flags to distinguish between clinical pathway data and process data. On the other hand, if different data schemata are used, it is easy to discriminate between care record and clinical pathway data; however, for both data to be handled uniformly, it is necessary to create a temporary table which contains both data, or to include both data as internal data for the analysis software used, or to make the program have a function capable of handling both data uniformly. FIG. 4 shows a star schema but the schema which may be used here is not limited thereto. For example, instead of the star schema, a snow flake schema may be used where a table showing diagnosis related groups associated with the “Diagnosis” column in the patient table is added. In this case, the tables can be easily modified but the speed of data extraction or retrieval may decrease because of an increase in the number of tables to be joined. The data schema may be varied depending on the frequency of table modification or the required data extraction response time.

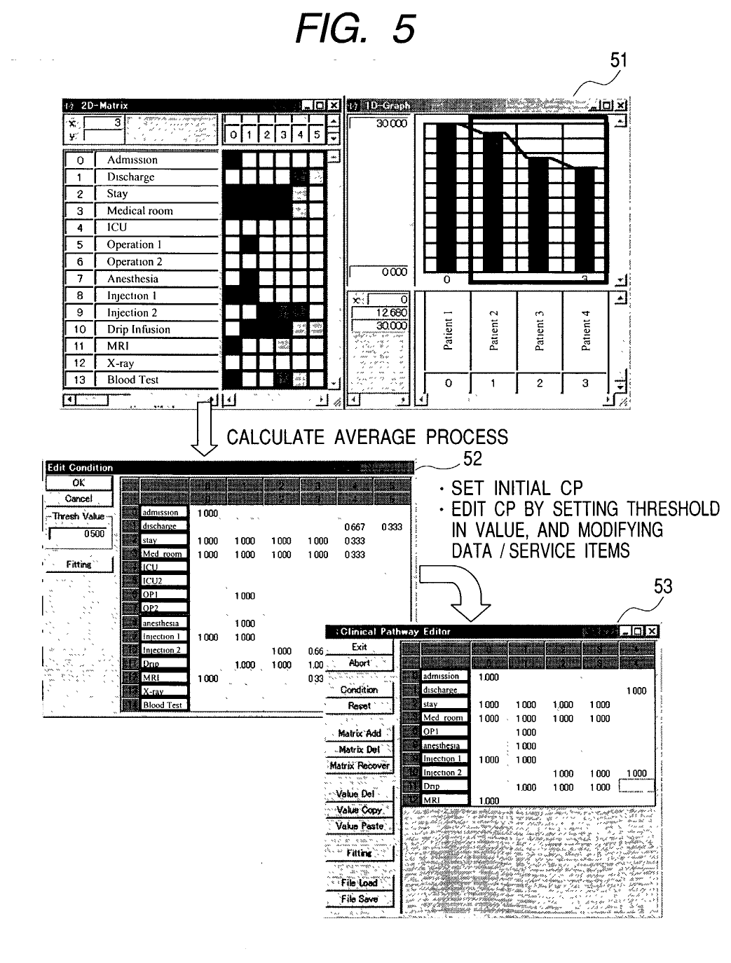

FIG. 5 shows a typical screen transition in the method of making a clinical pathway according to the present invention. In a care process display screen 51, a care process is shown on the left, where the horizontal axis represents the number of days which have elapsed since admission, the vertical axis represents clinical service items and the gray level indicates the amount of service rendered. On the right is a graph showing the amount of service rendered to each patient where the horizontal axis represents patients and the vertical axis represents the amount of service. The figure here shows that the three patients on the right are selected and a process as the average or sum of the data on the three patients is displayed on the right-hand screen. As a button for making a clinical pathway is pressed here, an average process is calculated and an initial clinical pathway set screen 52 appears. If, for example, 0.5 is entered as the threshold value to omit a fraction of 0.5 in calculation of initial clinical pathway data, the initial data is set on a clinical pathway edit screen 53. The user who is going to complete a clinical pathway edits it or modifies numerical data and service item names on this screen as appropriate until the desired clinical pathway is obtained. The completed clinical pathway is stored. When the analysis screen and edit screen are synchronized in this way, a clinical pathway can be created efficiently.

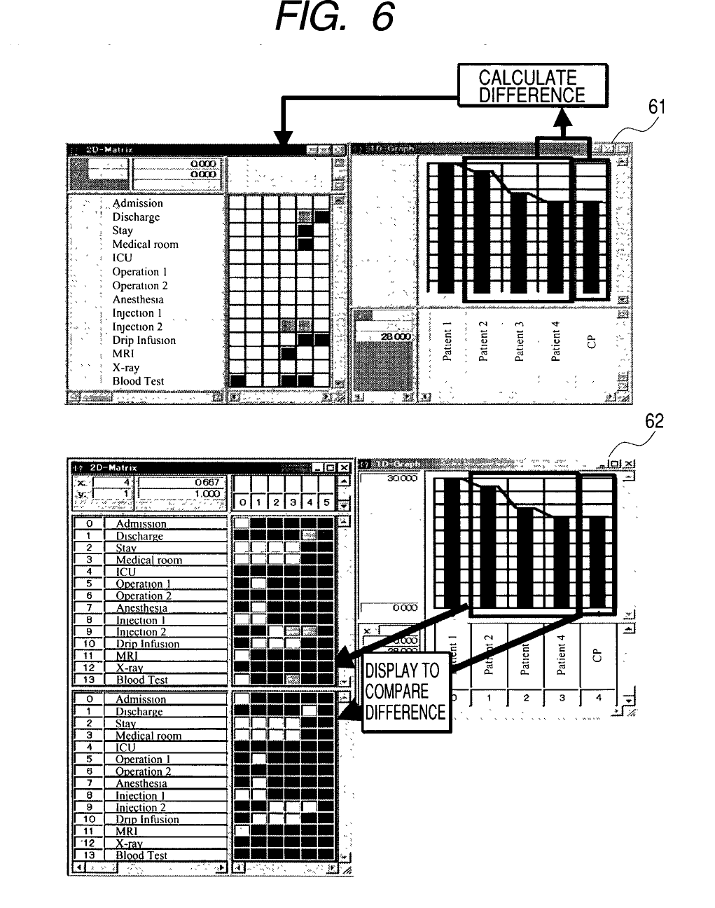

FIG. 6 shows two examples of care process display screens used to check a clinical pathway stored in the method of making a clinical pathway according to the present invention. On both care process display screens 61 and 62, the stored clinical pathway is shown at the rightmost end. On the care process display screen 61, the difference between the completed clinical pathway and the original care process based on which it has been made is calculated and displayed on the left. On the care process display screen 62, the completed clinical pathway and the original care process are displayed at a time vertically for easy comparison. Therefore, thanks to these display screens, a decision can be made easily as to whether the completed clinical pathway is appropriate to the actual care process.

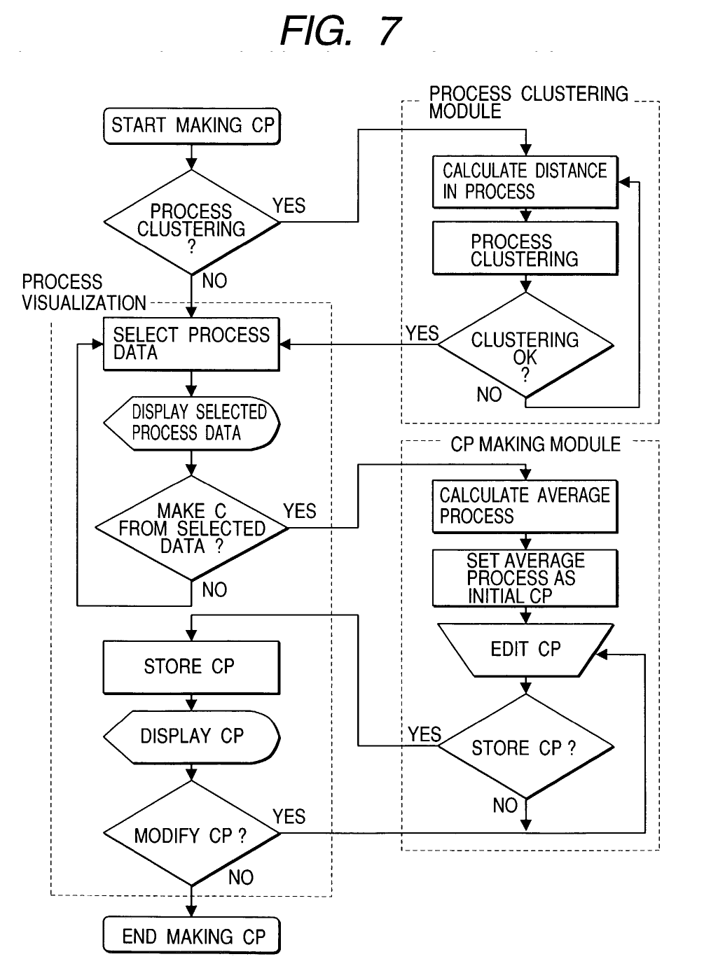

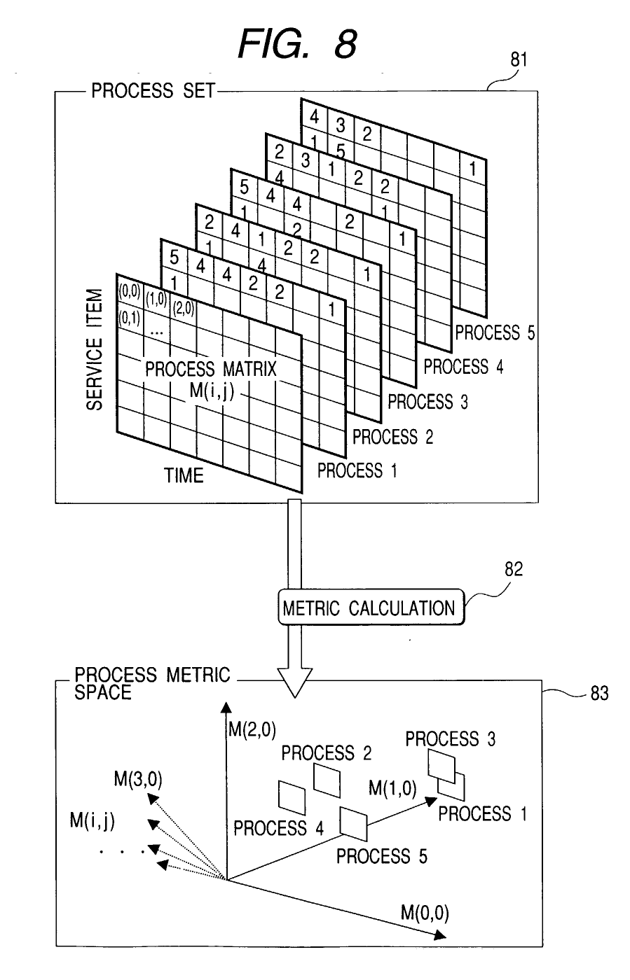

FIG. 7, a modified version of the flowchart in FIG. 3, shows how to improve the efficiency in making a clinical pathway. In the clinical pathway making sequence mentioned earlier, for the sake of efficiency improvement, it is important to select a patient group suitable for the desired clinical pathway. In other words, when a group of patients to whom uniform care processes have been applied is selected, the editing work can be reduced. In order to facilitate extraction of uniform processes, this flowchart has an additional step (clustering) in which an inter-process metric or distance between processes is defined and processes are classified according to the distance data. FIG. 8 is a conceptual diagram showing the definition of a distance between processes. A process set 81 is a set of two-dimensional matrices (time and service item axes) which each represent the record of care rendered to patients. Here, data in cells of each process matrix is clinical service quantitative data (amount, cost, medical treatment fee, dosage, test data, etc). Process metric space 83 is composed by introducing into this process set 81 Euclid metric (metric calculation 82) which assumes that the cells constitute an axis of multidimensional space. In other words, an inter-process metric (distance between processes) is defined as the root mean square of differences in clinical service quantity between cells. However, usually, some degree of error in the time dimension of care processes should be allowed, so each process may be broadened in the time dimension before modification by Euclid metric calculation or the like. In this case, the amount of broadening may be adjusted to match the required accuracy in timing of clinical service. For example, when no broadening is done, punctuality will be needed in clinical service; on the other hand, when the amount of broadening is considerable, clinical service may be carried out virtually at any time.

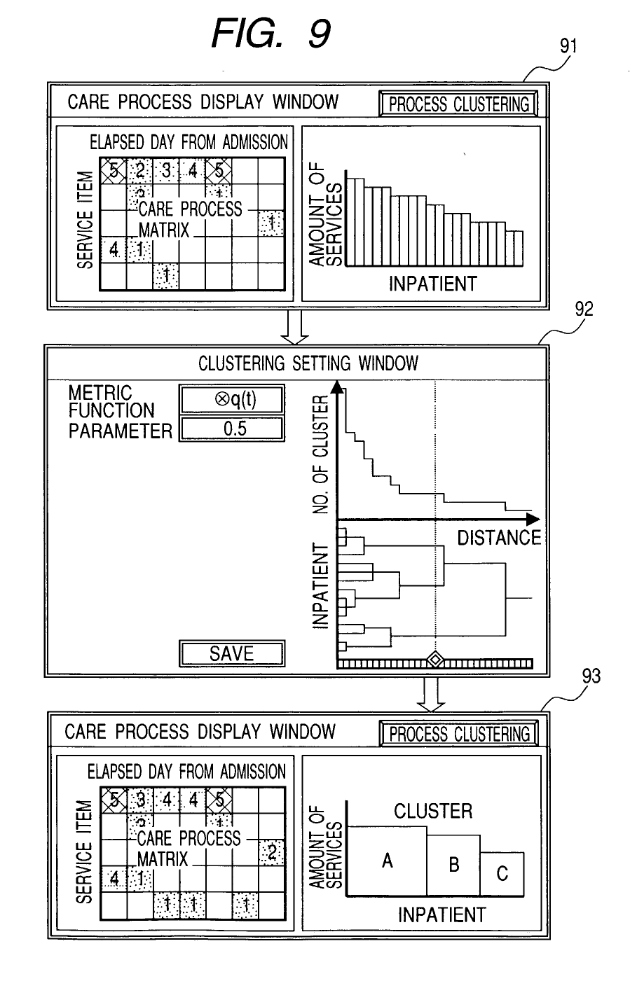

FIG. 9 shows a typical screen transition in this clustering step. A care process display window 91 shows a process data set. On the left is a two-dimensional matrix where the horizontal axis represents time (the number of elapsed days from admission), the vertical axis represents clinical service items and the gray scale indicates the average amount of service rendered. The one-dimensional graph on the right shows the amount of service to each patient. When a process clustering button is pressed, a cluster setting window 92 appears. In this window, the user can select a metric function used for clustering and enter a parameter which specifies the amount of broadening in the time dimension, though there are other metric definition parameters. As the user makes entries, the distance between processes is calculated and the processes are categorized using the nearest neighbor method or other clustering method. This figure shows a case that a hierarchical clustering method is adopted where the horizontal axis represents distance and the vertical axis in the upper graph the number of clusters and that in the lower graph each process (inpatient), with the lower graph showing, in the form of a dendrogram, how clusters are configured. The user uses a pointing tool such as a slider to select the desired cluster and presses the SAVE button. In a care process display window 93, the graph on the right in the window 91 is replaced by a new one which is based on the saved clusters. After carrying out the clustering step, as in the case shown in FIG. 5, the user selects a cluster, calculates an average process, sets an initial clinical pathway, and edits and saves it. When the distance between care processes is defined and clustering according to the distance is done in advance, a suitable process for the case in question can be efficiently selected.

Exemplary Embodiment 3

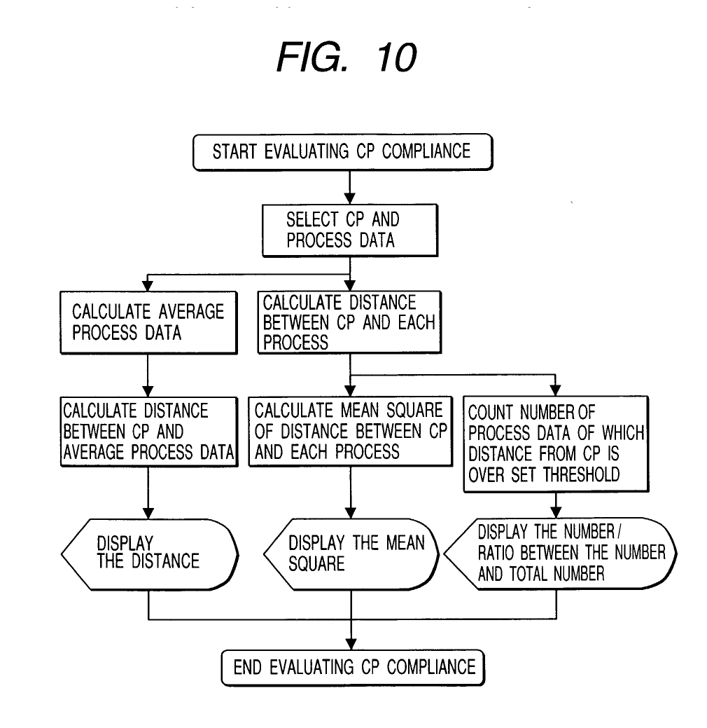

FIG. 10 shows the operational sequence for evaluating the degree of compliance between a clinical pathway and a care process using the distance between processes as described in the explanation of embodiment 2. This evaluation method is used in the care process evaluation module and clinical pathway evaluation module of the clinical pathway analysis environment 15 as shown in FIG. 1. First, the user selects process data and a clinical pathway between which the degree of compliance is to be evaluated. According to the first evaluation criterion, the average of the selected process data is calculated and the distance between the average process data and clinical pathway is calculated and displayed. This allows the user to know how much the average process is different from the clinical pathway. According to the second evaluation criterion, the square error in the distance between the clinical pathway and each process is calculated and displayed. This also allows the user to know how much processes are distributed with respect to the clinical pathway. According to the third evaluation criterion, a threshold for the distance from the clinical pathway is preset and the number or ratio of processes of which distance from the clinical pathway exceeds the threshold is counted and displayed. This permits the user to know the number or ratio of patients (so-called “outliers”) for whom the adopted care process is beyond the threshold. Therefore, the degree of compliance of care processes with the clinical pathway can be evaluated through all or one of the above-mentioned three evaluation criteria.

The result of this evaluation serves as a guideline for care process control in the care process evaluation module or a guideline for clinical pathway modification in the clinical pathway evaluation module. In addition, this evaluation method may be used to evaluate a clinical pathway made by the method of making a clinical pathway. In the example indicated by the flowchart in FIG. 3 and the clinical pathway display screens in FIG. 6, the clinical pathway and care processes are viewed for comparison. In this approach for evaluation, the difference is shown as numerical data and it is easy for the user to decide whether to modify the clinical pathway further.

Exemplary Embodiment 4

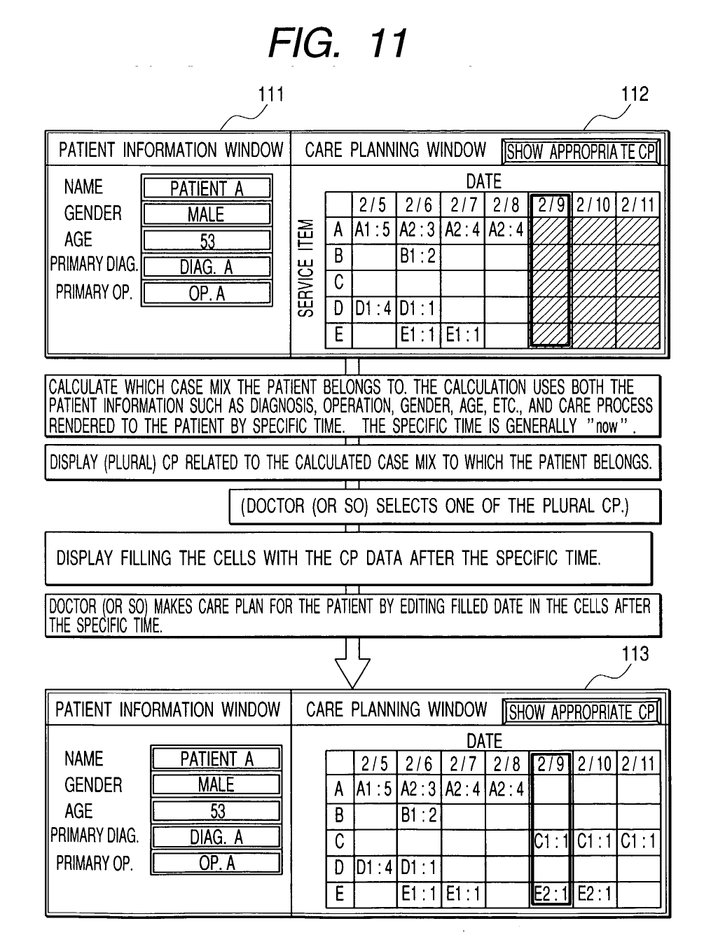

FIG. 11 shows a typical screen transition in the appropriate clinical pathway selection module 17. A patient information window 111 shows a patient's basic information. A care planning window 112 contains record of care rendered to the patient by a specific time and columns reserved for a planned care process. As shown in the figure, the horizontal axis represents dates while the vertical axis represents service items, and each cell is designed to show how much a certain type of clinical service has been rendered. Taking date February 5 (February 5) as an example, this table shows that five units of clinical service A1, which belongs to clinical service category A, and four units of clinical service D1, which belongs to clinical service category D, have been rendered to the patient on that day. The hatched part of the table after February 9 is space for a care plan to be drawn up from now on. As the user presses the “Show Appropriate CP” button, a case mix whose conditions are similar in terms of all or some factors of the patient basic care information (diagnosis, operation, gender, age, ethnic group, disease history, drug history, etc) and the record of care rendered by a specific time (February 8 in this example) is extracted, and a relevant clinical pathway is extracted from the case mix-clinical pathway relation database 16 shown in FIG. 1. To extract a similar case mix, it is important to choose a case mix which is equal or similar in terms of all or some (age, etc) factors of patient basic care information, according to the distance metric for the care process rendered by a specific time, as described in the explanation of embodiment 2. Here, more than one case mix may be extracted. Also, there may be more than one clinical pathway relevant to the extracted case mix. For a single case mix, more than one clinical pathway can be relevant because of the existence of uncategorized matters or restrictive factors concerning healthcare provider equipment or facilities.

When plural clinical pathways are displayed, they may be displayed in the order of priority according to the degree of similarity or the like. The user (doctor, etc) selects one from among clinical pathways displayed. Depending on the selected clinical pathway, relevant data appears in the care planning space. Taking the patient's status and availability of equipment or facilities into consideration, the user edits the data inserted into the care planning space on the care planning window 113. Then, the user can issue an order for clinical service, etc which can be reserved from the screen. This function (appropriate clinical pathway selection module) makes it possible to select an appropriate clinical pathway which suits not only the patient basic care information but also the patient's status and/or record of care rendered to the patient up to a specific time and also to draw up a care plan suitable for the patient in line with the selected pathway.

Exemplary Embodiment 5

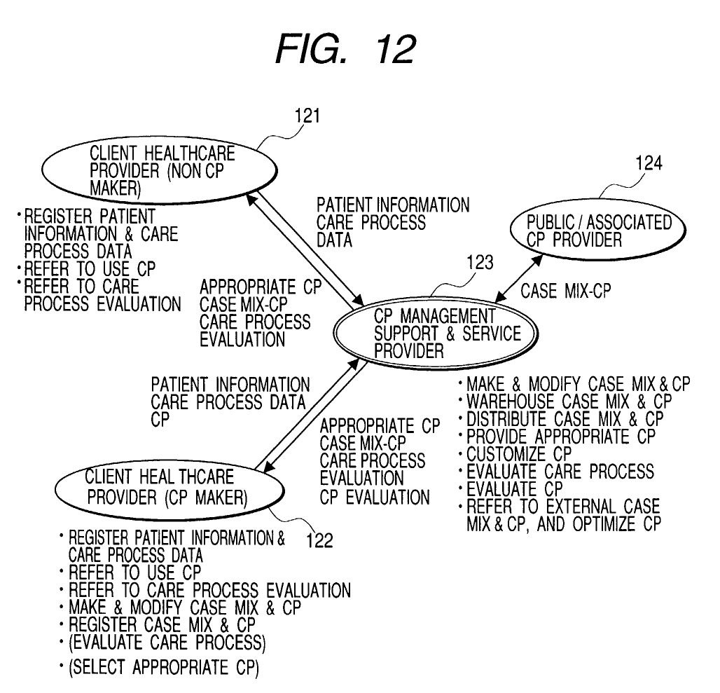

FIG. 12 outlines the structure of the clinical pathway management support information system according to the present invention. In the figure, CP stands for clinical pathway. A client healthcare provider (non CP maker) 121 and a client healthcare provider (CP maker) 122 are clients for this service; a clinical pathway management support & service provider 123 is a server for this service; and a public/associated clinical pathway provider 124 is another server which is in partnership with the provider 123 regarding this service or an organ which publicizes clinical pathways, etc. In the figure, the bulleted lists indicate tasks for which the respective organs are responsible; and shown next to each arrow is information to be distributed. In the client healthcare provider (non CP maker) 121, patient information and care process data are registered and sent to the clinical pathway management support & service provider 123. The clinical pathway management support & service provider 123 received the delivered data, selects an appropriate clinical pathway and sends back the selected clinical pathway to the client healthcare provider (non CP maker) 121. The clinical pathway management support & service provider 123 customizes the clinical pathway according to restrictions for the client healthcare providers such as availability of equipment/facilities and the course of care adopted and sends the customized data to the clients. Furthermore, the clinical pathway management support & service provider 123 makes, modifies and warehouses case mixes and clinical pathways using care process data collected from the clients. The warehoused data is used to select appropriate clinical pathways or distribute case mixes or clinical pathways. Also, the clinical pathway management support & service provider 123 evaluates care processes using care process data collected from clients, and distributes the result of care process evaluation to client healthcare providers. This care process evaluation takes place as follows: collected care process data is classified into registered case mixes and the degree of compliance of each case mix is calculated according to the distance from the clinical pathway associated with the case mix.

Besides, the clinical pathway management support & service provider 123 evaluates clinical pathways using care process data collected from clients and modifies clinical pathways. The client healthcare provider (CP maker) 122 receives the same service as the client healthcare provider (non CP maker) 121. In addition, it makes and modifies case mixes and clinical pathways and registers them into the clinical pathway management support & service provider 123. The clinical pathway management support & service provider 123 warehouses, delivers and modifies the registered case mixes and clinical pathways. Also it evaluates the registered clinical pathways according to the collected care process data and delivers the evaluation to the client healthcare provider (CP maker) 122.

The client healthcare providers may have various functions. For instance, it is likely that they individually select appropriate clinical pathways or evaluate care processes. Also, the clinical pathway management support & service provider 123 may play the role as a healthcare provider.

The fee to be paid to the server by a client may be determined at a fixed rate, or depending on the amount of clinical pathways consumed or on the number of service items contracted or the amount of service provided. On the other hand, if the client healthcare provider (CP maker) registers a clinical pathway, depending on how much the registered clinical pathway is used, the amount payable may be reduced or the clinical pathway management support & service provider 123 may have to pay a fee to that client healthcare provider.

When care process data is collected from plural healthcare providers in this way, the quality and accuracy of clinical pathways and case mixes can be improved, leading to improvement in the quality and efficiency of clinical service at healthcare providers. In addition, comparison among healthcare providers may reveal which points of clinical service should be improved.

As aforementioned, the present invention provides an information system which analyzes care record and feeds back the analysis result to clinical service or a healthcare provider. Particularly, the use of clinical pathways produces a remarkable effect that information can be efficiently fed back. The clinical pathway making method employed in the invention helps make and modify clinical pathways in a way which suits actual care processes. The appropriate clinical pathway selection method employed in the invention permits selection of an appropriate clinical pathway according to patient information and the record of care rendered by a specific time. The care process evaluation method and clinical pathway evaluation method employed in the invention use the difference between care record and a clinical pathway as an index, which contributes to improvement in the quality of clinical pathways and clinical service. When clinical pathways are widely distributed through the information system according to the present invention, it is possible to provide support and information service which helps healthcare providers offer higher quality and more efficient clinical service.

The foregoing invention has been described in terms of preferred embodiments. However, those skilled, in the art will recognize that many variations of such embodiments exist. Such variations are intended to be within the scope of the present invention and the appended claims.

What is claimed is:

1. A clinical pathway management support information system comprising:
(a) means for recording care processes electronically;
(b) means for making case mixes and clinical pathways from the recorded care processes;
(c) means for storing the case mixes and clinical pathways thus made; and
(d) means for selecting an appropriate clinical pathway from among the clinical pathways stored in the storing means.

2. A clinical pathway management support information system comprising:
(a) means for recording care processes electronically;
(b) means for making case mixes and clinical pathways from the recorded care processes;
(c) means for storing the case mixes and clinical pathways thus made;
(d) means for selecting an appropriate clinical pathway from among the clinical pathways stored in the storing means; and
(e) means for calculating the degree of compliance between the recorded care process and the stored clinical pathway.

3. A method of supporting clinical pathway management, comprising the steps of:
(a) classifying electronically recorded care processes for plural patients in the form of two-dimensional matrices composed of a time axis and a clinical service axis;
(b) calculating an average process of care processes selected from among the care processes by a user;
(c) providing the user with means for editing the average process;
(d) registering the average process edited by the user into a database as a clinical pathway;
(e) registering a case mix to which the clinical pathway is to be applied, into a database in relation with the clinical pathway;
(f) receiving data on care process rendered to a patient by a specific time;
(g) extracting a case mix whose data is similar to the data on care process rendered by the specific time;
(h) selecting a clinical pathway related to the case mix; and
(i) outputting a care process plan to be followed after the specific time.

4. A method of making a clinical pathway, comprising the steps of:
(a) selecting care processes to be analyzed from care process storing means;
(b) calculating an average process of the selected care processes;
(c) setting the average process as an initial clinical pathway;
(d) providing a user with means for editing the initial clinical pathway; and
(e) storing the edited clinical pathway into a database.

5. The method of making a clinical pathway as claimed in claim 4, wherein in the step of selecting care processes, care processes are selected using care process display means which comprises:
(a) means for displaying time-series pattern statistics of care processes using a two-dimensional matrix consisting of time and service items;
(b) means for displaying statistics for each care process using a one-dimensional graph; and
(c) means for selecting a region of interest on both graphs and displaying only care processes which fall within the region of interest.

6. The method of making clinical pathways as claimed in claim 4, wherein at the step of selecting care processes, a metric or distance between care processes is defined and clustering of care processes is done according to the metric and care processes are selected by selecting one or more of the care process clusters.

7. A method of evaluating the degree of compliance between a clinical pathway and a care process, including means for calculating the metric or distance between an electronically recorded care process and a clinical pathway, in which, with regard to distances of the care process from the clinical pathway, calculations are made for all or some of the following items: average, variance, mean square error and the number or ratio of care processes which are beyond a specific threshold.

8. A method of selecting a clinical pathway, comprising the steps of:
(a) entering care process data on care rendered by a specific time;
(b) calculating a case mix similar to the care process data; and
(c) extracting a clinical pathway related to the case mix to use it as a care plan to be followed after a specific time.

9. Clinical pathway providing service comprising the steps of:
(a) receiving electronic record of a care process;
(b) analyzing the recorded care process and making a case mix and a clinical pathway; and
(c) delivering the case mix and clinical pathway thus made.

10. Clinical pathway providing service comprising the steps of:
(a) receiving electronic record of plural care processes;
(b) categorizing the care processes into a stored case mix;
(c) calculating a degree of compliance from distances of the categorized care processes from a clinical pathway related to the case mix; and
(d) returning the case mix and the degree of compliance.

11. Clinical pathway providing service comprising the steps of:
(a) receiving electronic record of a care process rendered to a patient by a specific time;
(b) calculating a case mix similar to the care process;
(c) extracting a clinical pathway related to the case mix; and
(d) returning the clinical pathway as a care plan to be followed after a specific time.
